(19) United States
(12) Patent Application Publication
(10) Pub. No.: US 2010/0051409 A1
(43) Pub. Date: Mar. 4, 2010

(54) DEVICE FOR ENCLOSING FINE DUST FROM CLUTCHES

(75) Inventor: Wilhelm Hardtle, Markdorf (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/447,557

(22) PCT Filed: Oct. 12, 2007
(86) PCT No.: PCT/EP2007/060884

§ 371 Date: Apr. 28, 2009

(30) Foreign Application Priority Data
Nov. 4, 2006 (DE) 10 2006 052 101.3

(51) Int. Cl. F16D 13/58

(52) U.S. Cl. 192/112

(57) ABSTRACT

A device for encapsulating fine clutch dust is proposed which comprises caverns (5) provided in the clutch housing (4) for collecting fine dust by the rotation-related centrifugal force. During servicing of the clutch, the fine dust received in the caverns (5) can be removed.

This application is a National Stage completion of PCT/EP2007/060884 filed Oct. 12, 2007, which claims priority from German patent application serial no. 10 2006 052 101.3 filed Nov. 4, 2006.

### FIELD OF THE INVENTION

The present invention relates to a device for encapsulating fine clutch dust.

### BACKGROUND OF THE INVENTION

According to the state of the art, friction clutches are typically inserted between the engine and the transmission in the vehicle. To this end, the friction clutches, which are used, wear-out multiple times over the course of the service life of the vehicle, whereby significant volumes of fine dust are generated and disadvantageously emitted into the environment, via outlet openings, as a result of swirling and other effects. These dusts are a burden, in part toxic and endanger, among other things, the health of people, in particular, via the lungs.

From DE 19911578 A1 by the applicant, a device is known for cleaning lubricants and coolants in components having rotating elements, particularly gear wheels in gear housings. The rotating elements are hereby associated with centrifugal force chambers for receiving and depositing dirt and abrasion particles. Furthermore, a system is known from U.S. Pat. No. 5,349,884 for mounting a dust shield system on a clutch housing.

### SUMMARY OF THE INVENTION

The basic object of this invention is to provide a device which allows the encapsulation of fine clutch dust in a simple manner.

The invention proposes encapsulating the fine clutch dust from abrasion of the linings and the house, in the clutch transmission space such that it cannot penetrate to the outside.

The design, according to the invention, additionally prevents penetration of the abrasive dust to the outside, whereby the service life of the clutch under extreme environmental conditions is advantageously increased.

According to an advantageous embodiment of the invention, caverns are provided in the clutch housing in which fine dust is collected as a result of the rotation-related centrifugal force. It is provided, within the scope of an advantageous refinement, that the fine dust received in the caverns can be removed by way of a suitable removal possibility. The removal possibility can be implemented, for example, in that each cavern is associated with a cover such that, by opening the covers, the fine dust received in the caverns can be removed.

According to the invention, it may also be provided, that the caverns be disposed on a separate part, in order to remove the fine dust received in the caverns, said separate part being able to be displace, by rotation and/or axially, in the circumferential direction so that the part, comprising the caverns, can be removed as a whole. This part is preferably configured as a circular cylinder on which the caverns are provided.

### BRIEF DESCRIPTION OF THE DRAWINGS

The invention will be explained in more detail below based on the attached figures.

Shown are:

FIG. 1 is a schematic view of the arrangement of a friction clutch, between the driving motor and the transmission of a motor vehicle, and the device for encapsulating the fine clutch dust, and

FIG. 2 is a front view of a section along the line A-A from FIG. 1.

### DETAILED DESCRIPTION OF THE PREFERRED EMBODIMENTS

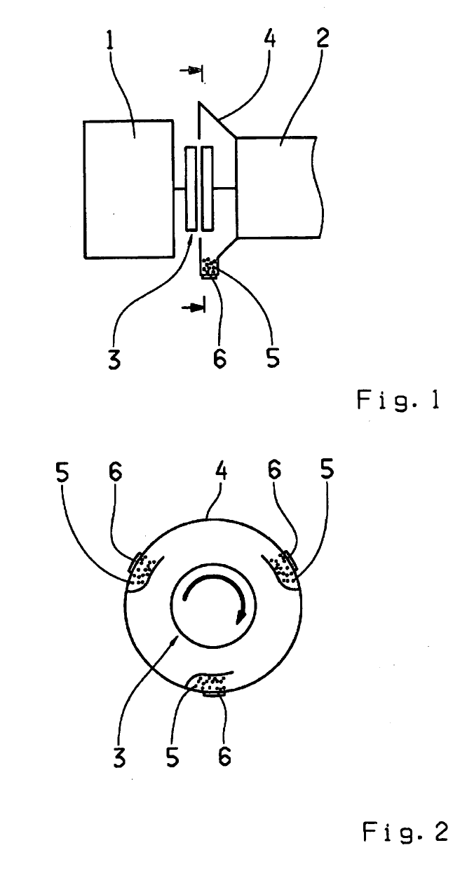

In FIG. 1, a friction clutch 3 is shown which is disposed between the driving motor 1 and the transmission 2 of a motor vehicle. According to the invention, caverns, 5 are provided in the clutch housing 4 for encapsulating the fine clutch dust in which the fine dust is collected by a rotation-related centrifugal force. In the attached figures, the fine dust is illustrated by the dots shown in the caverns 5.

In FIG. 2, the rotational direction of the clutch is illustrated by the arrow; due to the rotation-related centrifugal force, the fine dust is collected in the caverns 5. In the embodiment shown, each cavern 5 is associated with a cover 6, whereby the fine dust received in the caverns 5 can be easily removed.

The design according to the invention provides a device that enables the encapsulation and subsequent removal of fine clutch dust in a simple manner.

### REFERENCE NUMERALS

1 Driving motor
2 Transmission
3 Friction clutch
4 Clutch housing
5 Cavern
6 Cover

1-4. (canceled)

5. A device for encapsulating fine clutch dust during operation of a clutch, wherein the clutch comprises caverns (5), provided in the clutch housing (4), and the fine dust collects in the caverns (5), due to rotation-related centrifugal force, and the fine dust received in the caverns (5) can be removed.

6. The device for encapsulating fine clutch dust according to claim 5, wherein each cavern (5) has a cover (6) associated therewith and the fine dust, received in the caverns (5), is removed by opening the covers (6).

7. The device for encapsulating fine clutch dust according to claim 5, wherein the caverns (5) are located on a separate part which is at least one of rotatable and axially displaced, in a circumferential direction, such that the part comprising the caverns (5) is removed as a whole.

8. The device for encapsulating fine clutch dust according to claim 5, wherein the part comprising the caverns (5) is a circular cylinder.

9. A device for encapsulating fine clutch dust created during operation of a clutch, wherein the clutch comprises caverns (5) provided, within the clutch housing (4), and centrifugal force, generated by rotation of the clutch, causes the fine dust collects to collect in the caverns (5) and, during servicing of the clutch, the fine dust which collects in and is received in the caverns (5) is removed.
